(19) United States
(12) Patent Application Publication
(10) Pub. No.: US 2013/0054311 A1
(43) Pub. Date: Feb. 28, 2013

(54) SYSTEMS, METHODS AND COMPUTER PROGRAM PRODUCTS FOR RIDE SHARING BASED ON MILEAGES

(71) Applicants: Ajay Kataria, Westborough, MA (US); Adeline Kuo, Whitestone, NY (US); Anjuli Kannan, Danbury, CT (US)

(72) Inventors: Ajay Kataria, Westborough, MA (US); Adeline Kuo, Whitestone, NY (US); Anjuli Kannan, Danbury, CT (US)

(73) Assignee: Miles2Share LLC, Westborough, MA (US)

(21) Appl. No.: 13/597,764

(22) Filed: Aug. 29, 2012

Related U.S. Application Data
(60) Provisional application No. 61/529,239, filed on Aug. 30, 2011.
(60) Provisional application No. 61/622,589, filed on Apr. 11, 2012.

(51) Int. Cl. G07B 15/02

(52) U.S. Cl. 705/13

(57) ABSTRACT

To reduce our carbon footprint on the planet, there needs to be better systems and methods of coordinating travel among people. The presently disclosed system not only allows for ride sharing to take place, the driver can also be rewarded with financial incentives while the passenger not only is able to get to the desired destination, he or she can also save money by not having to maintain a vehicle, not to mention numerous other benefits to the environment and society.

### CROSS REFERENCE TO RELATED APPLICATIONS

This application claims priority to U.S. Provisional Patent Application Ser. No. 61/529,239 filed Aug. 30, 2011, and U.S. Provisional Patent Application Ser No. 61/622,589 filed Apr. 11, 2012, each of which is incorporated herein by reference.

### BACKGROUND

Traffic congestions from going to work or school and attending sporting events or other outdoor activities, for example, can be mentally challenging, not to mention financially costly and bad for the environment as cars sit idle. Accordingly, there needs to be better systems and methods of coordinating rides with other people to reduce our carbon footprint on the planet.

### SUMMARY

In one embodiment, a method of ride sharing includes (a) receiving information from one or more members, (b) classifying the one or more members as driver, passenger or both, (c) matching at least a portion of the information from one or more members, wherein the information includes a trip, (d) providing contact information between at least one driver and at least one passenger depending on the amount of overlap of the trip, wherein the amount of overlap exceeds a pre-determined threshold, and (e) rewarding the driver the number of miles travelled based on the trip.

In one embodiment, the trip of step (c) includes a starting point and a destination point. In another embodiment, the pre-determined threshold of step (d) is at least 75%. In another embodiment, the pre-determined threshold of step (d) is at least 90%. In another embodiment, the matching step (c) further includes validating the one or more members having sufficient number of miles in his or her account if the member is classified as a passenger.

In one embodiment, concomitant to the providing step (d), allowing the passenger to purchase the number of miles necessary before scheduling a ride with a driver

Other variations, embodiments and features of the present disclosure will become evident from the following detailed description, drawings and claims.

### BRIEF DESCRIPTION OF THE DRAWINGS

FIG. 1 is a diagram of a ride sharing system according to mileages based on one embodiment of the present disclosure.

FIG. 2 is a diagram of a set of parameters with prior permission that may be shared with other members to create the different sharing circles associated with the system.

FIG. 3 illustrates the creation of the ‘subset,’ ‘super-subset,’ and ‘optimal overlap’ circles associated with the system.

FIG. 4 is a diagram showing the associated system update and service processes.

FIG. 5 illustrates and defines the ‘subset,’ ‘super-subset,’ and ‘optimal overlap’ circles associated with the system.

FIG. 6 is a diagram of the share information exchange module associated with the system.

FIG. 7 is a diagram showing the miles exchange process associated with the system.

FIG. 8 is a diagram of a rating module for drivers and riders associated with the system.

FIGS. 9-10 are example screenshots of how the ride sharing system can work to help with a member's daily commute.

### DETAILED DESCRIPTION OF THE DISCLOSURE

It will be appreciated by those of ordinary skill in the art that the embodiments disclosed herein can be embodied in other specific forms without departing from the spirit or essential character thereof. The presently disclosed embodiments are therefore considered in all respects to be illustrative and not restrictive.

One embodiment is a system that creates a social circle that encourages and believes in sharing of cars or vehicles based on miles exchange and thus reducing carbon footprint. Additionally, methods and computer program products associated therewith may also be contemplated. The service may provide exchange and technological support by bringing two or more members, one driver (e.g., person driving his or her own vehicle) and one or more riders (e.g., person using another person's car) to share a ride based on mileages. In some embodiments, all users may have to sign up with a service provider and provide information (e.g., driving records, credit history) for background checks. In operation, based on the sharing services a rider's account may be charged with the shared miles while a driver's account may earn the same number of miles.

In one embodiment, a user or member may register with the service provider and provide their daily commute/event commute information. Based on the information provided by the members and possible overlap based on match of starting and ending point as well as based on starting time and ending time, circles of expected ‘subset’ members, ‘super-subset’ members and ‘optimal overlap’ members may be generated. Any changes in a member's schedule (e.g., starting time, ending time, starting point, ending point) may be updated by the member on the system and can be matched to available options based on existing members, new members, replaced members, among others, as needed.

The system may track the mileages shared by different members: (a) members offering their car for share (e.g., drivers) and (b) members who want to get a ride (e.g., riders or passengers). Drivers may earn ‘miles’ and riders or passengers may spend ‘miles.’ In some embodiments, members may have to become drivers first and earn miles in order to participate as riders. In other embodiments, members may buy mileages upfront and use them as passengers.

Examples where the disclosed system, method and computer program products may be useful include common places or events or trips attended by a plurality of people including without limitation commuting back and forth from work, going to a sporting game or other types of events, and any other frequent overlapping routes.

In one embodiment, a method of ride sharing includes (a) receiving information from one or more members, (b) classifying the one or more members as driver, passenger or both, (c) matching at least a portion of the information from one or more members, wherein the information includes a trip, (d) providing contact information between at least one driver and at least one passenger depending on the amount of overlap of the trip, wherein the amount of overlap exceeds a pre-determined threshold, and (e) rewarding the driver the number of miles travelled based on the trip.

In one embodiment, the trip of step (c) includes a starting point and a destination point. In another embodiment, the pre-determined threshold of step (d) is at least 75%. In another embodiment, the pre-determined threshold of step (d) is at least 90%. In another embodiment, the matching step (c) further includes validating the one or more members having sufficient number of miles in his or her account if the member is classified as a passenger. In one embodiment, concomitant to the providing step (d), allowing the passenger to purchase the number of miles necessary before contact information about the driver is provided.

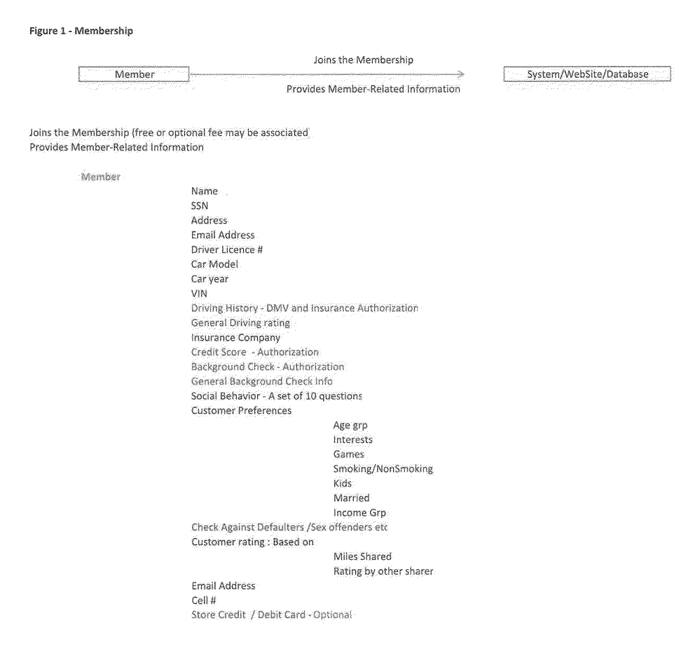

Reference is now made to FIG. 1 which diagrams a platform or system that allows members to share rides by making ‘sharing of ride’ more attractive and dynamic, provides flexible scheduling options, and takes the headaches out of who will be doing the driving and other factors, among other benefits. There may be incentives which may encourage drivers as well as riders. In one embodiment, it may be required that each member has his or her own vehicle in order to become a member in the system. As membership increases over time ‘sharing’ may become more feasible.

Some of the benefits to members include, without limitation, money, time, reduced dependence on oil, reduced carbon footprint, and companionship. Each member may also have to provide his or her own personal information, examples of which are shown in FIG. 1. The information may be used to ensure that each member is serious about ride sharing, trustworthy and credit worthy, and eliminate any security and safety issues or concerns.

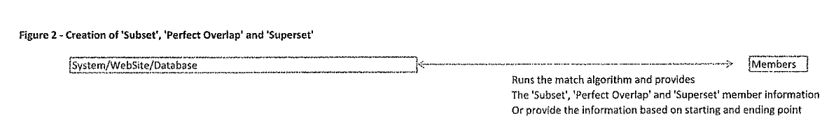

Reference is now made to FIG. 2 which diagrams that there may be a certain set of parameters with prior permission of members that may be shared with other members to help create ‘subset,’ ‘super-subset,’ or ‘optimal overlap’ circles. In some embodiments, in lieu of services member may be expected to: (a) pay a membership fee; (b) pay to buy miles; or (c) pay a fee based on the shared miles. The frequency and the amount of the associated fees may be determined by the system.

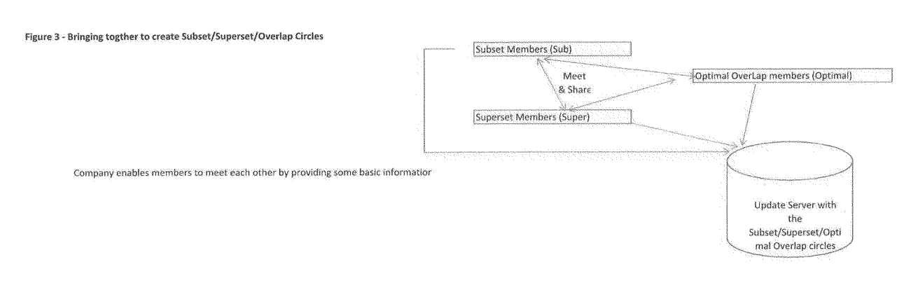

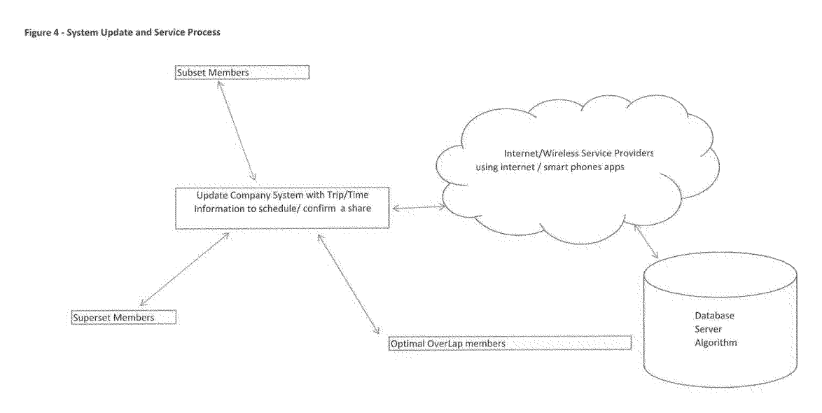

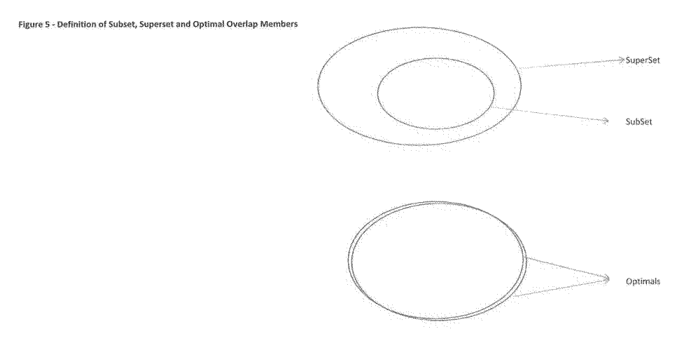

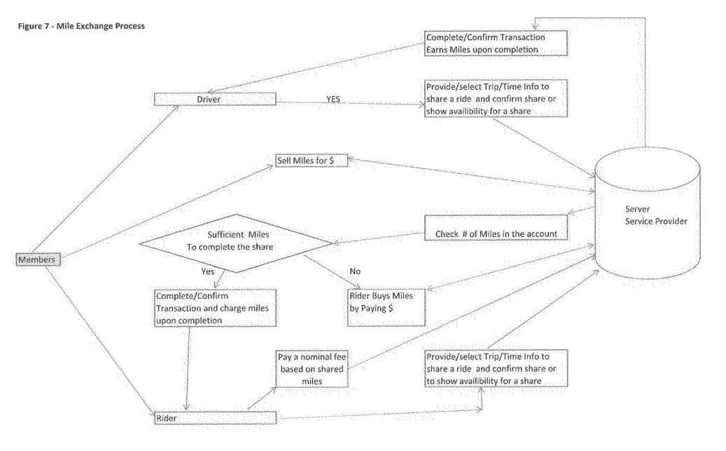

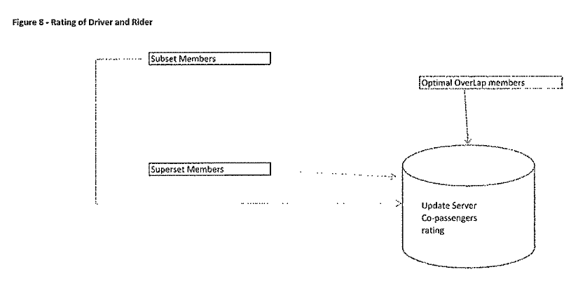

In one embodiment, each member can create his or her own ‘subset,’ ‘super-subset,’ and ‘optimal overlap’ circles as illustrated in FIGS. 3 and 5. These circles may be freely created but there may be cost associated with using the services provided by the system. A mileage exchange program, part of the system, may track the number of miles shared and credit or debit the accounting depending on if the member was a driver or a rider/passenger. To share miles members may have to earn or buy the miles. In some instances, miles may be given, transferred or exchanged between members.

Reference is now made to FIG. 5 which illustrates and defines the ‘subset,’ ‘super-subset,’ and ‘optimal overlap’ circles. To share a ride a member needs to have some overlap of the routes. Based on the extent of the overlap a member can be categorized as one of the three circles. To be a categorized as a subset member the member route may be a part of another member and the ‘subset’ member can be a rider but not a driver. To be categorized as a super-subset member the distance and route travelled by the member may be the longest and the other members are ‘subset’ of this member. This member may be the default driver to its ‘subset’ members. To be categorized as an optimal overlap member the distance and route travelled may be at least 90% in common between two or more members. At least one of the members has to be a driver while the others can be riders or passengers.

Reference is now made to FIG. 3 illustrating the creation of the ‘subset,’ ‘super-subset,’ and ‘optimal overlap’ circles. Based on the information provided by the members, the system may generate a list of suggested ‘subset’ members. ‘Super-subset’ members and ‘optimal overlap’ members for a member (e.g., X) and provide these members' permissible information to member X. Member X may reach out to the interested members to gain comfort level to share a vehicle in the future. Using the list of ‘subset,’ ‘super-subset,’ and ‘optimal overlap’ members, member X may create a personalized listing of members who may be member X's own ‘subset,’ ‘super-subset,’ or ‘optimal overlap’ circle of members to be considered for ride sharing in the future.

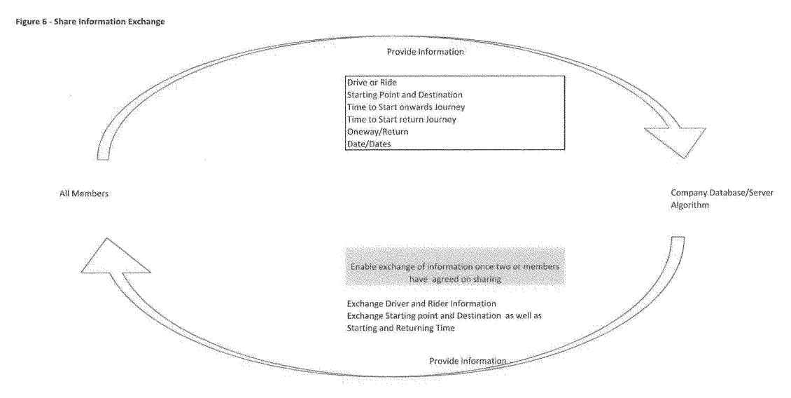

Reference is now made to FIG. 4 which diagrams associated system update and service processes. When member X needs to share a ride either by being a driver or a rider, member X may update the time/date of departure on the system using the Internet or a mobile device including without limitation an application on the mobile device. Members in member X's ‘subset,’ ‘super-subset,’ or ‘optimal overlap’ circle may be notified or see member X's availability in real-time. If the time/date of departure works for any one of the other members in member X's circles, that information may be shared to the other members in a similar fashion as discussed above.

Reference is now made to FIG. 6 which diagrams share information exchange associated with the system. After selecting ‘subset,’ ‘super-subset,’ and ‘optimal overlap’ circles members and accepting the terms and conditions of ride sharing, detailed schedule information may be shared with members. The members in each ‘subset,’ ‘super-subset,’ and ‘optimal overlap’ circles can see another member's schedules, starting and destination points, and may select the best fit for sharing rides. A member may be able to select a ride share either by selecting one day or multiple days which may result into, for example, sharing five days of riding into work with the same member for five days of riding into work with five different members each day. When the ride share is selected both members receive detailed information including without limitation starting point, destination point, starting time, ending time, one way or round trip. Once accepted the information is transmitted to other members of the ride share.

In one embodiment, each member may have to actively update the status of their availability on the system. For example, this may include starting point, destination, starting time, ending time for each day up to a month at a time. In other instances, updates can be made on a weekly basis. Each member may have the option to select different start time and end time. Once the member status has been updated and the member's information or availability is provided, the status will be open (O) and available. Otherwise the member's status will not be available (NA) to other members. By making and showing availability and opting to be driver or rider means each member is agreeing to accept sharing from other members in the circle.

In operation, when a proposed share from other members in the circle has been accepted, the status may be changed to booked (B) to reflect that at least one other member has accepted the proposed share. Once the share has been concluded the driver will earn the miles and the rider or riders will spend the miles.

Reference is now made to FIG. 7 which diagrams the miles exchange process associated with the system. In one embodiment, to conclude a share of ride, there may be an exchange of miles between the driver and the rider or riders. A driver will earn the miles while the rider or riders will spend the miles. For instance, before the rider confirms the ride share, the system will check to see if the rider has enough miles to share. If the rider does not, the rider will have to buy the miles at the published rate or become a driver first to earn miles. In one embodiment, besides exchanging of miles between driver and rider, the rider may have to pay a nominal fee of x cents per mile or y % of shared miles. In one embodiment, the driver will earn miles by sharing his or her vehicle. If desired, the miles can be cashed in once a month at the published rate. To ensure that members are readily available as riders as well as driver, there may be enough rate differences between what a rider will pay if it decides to buy miles versus cashing out the miles (e.g., prices for buying miles may be higher than prices granted for cashing out the miles earned).

In one embodiment, members can track the details of earned miles and values of their accounts online at any time on the system. Statements may show activity during the last calendar month including without limitation miles used, miles earned, miles purchased, outstanding miles, and account value in dollars as well as miles. In one embodiment, any accumulated miles over 2,500 may be automatically cashed out. If a ride share should not occur for some reason, either the driver or one of the riders may go to the conflict management module of the system and explain their reasoning for this. Once the reasoning has been provided and confirmed with other members the account will reflect the reversed transaction.

Reference is now made to FIG. 8 which diagrams a rating module for the driver and riders associated with the system. The purpose of this system is to encourage ride sharing instead of the standard car pooling or taxi services as members share miles as a driver or rider. This information may result into a rating system for the driver as well as the riders. Both the driver and rider may be able to comment on their ride share experience and rate each other based on some predefined criteria/options. The rating system helps drivers and riders find suitable members and may be automated to improve the system's reliability and usefulness.

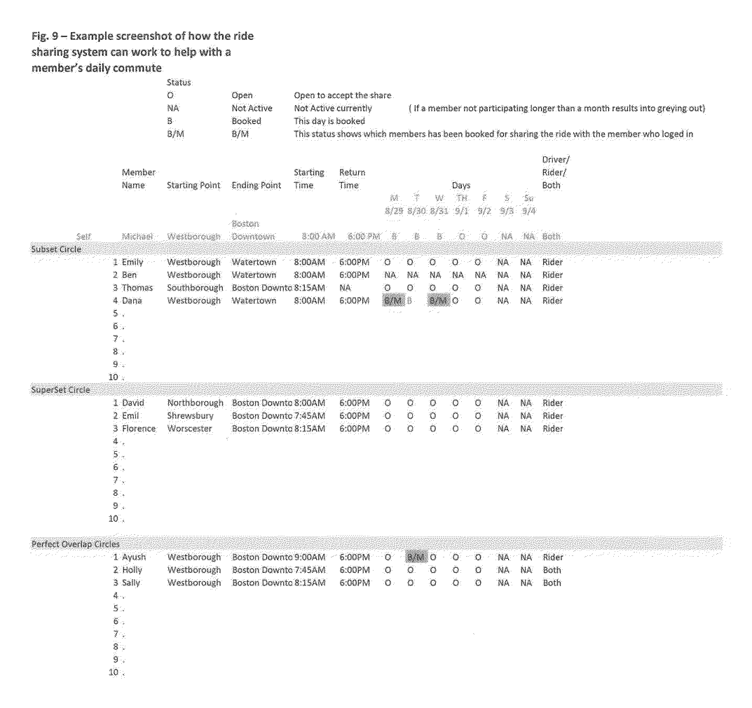

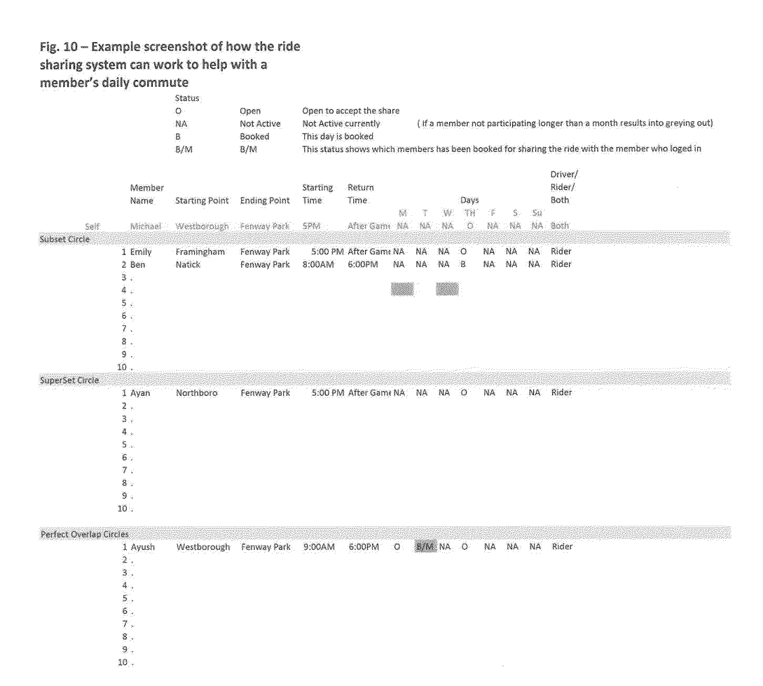

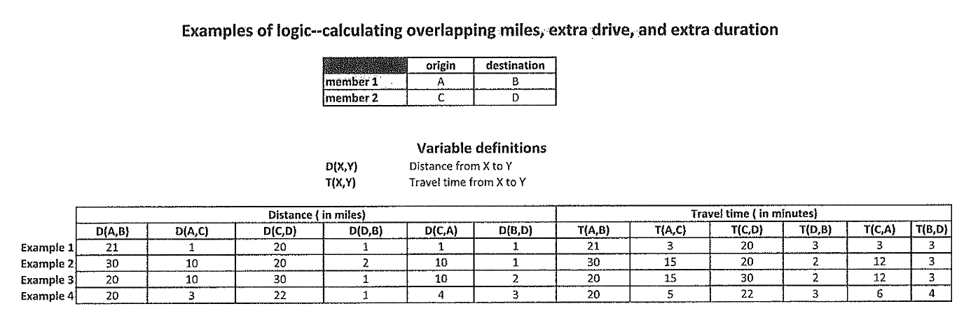

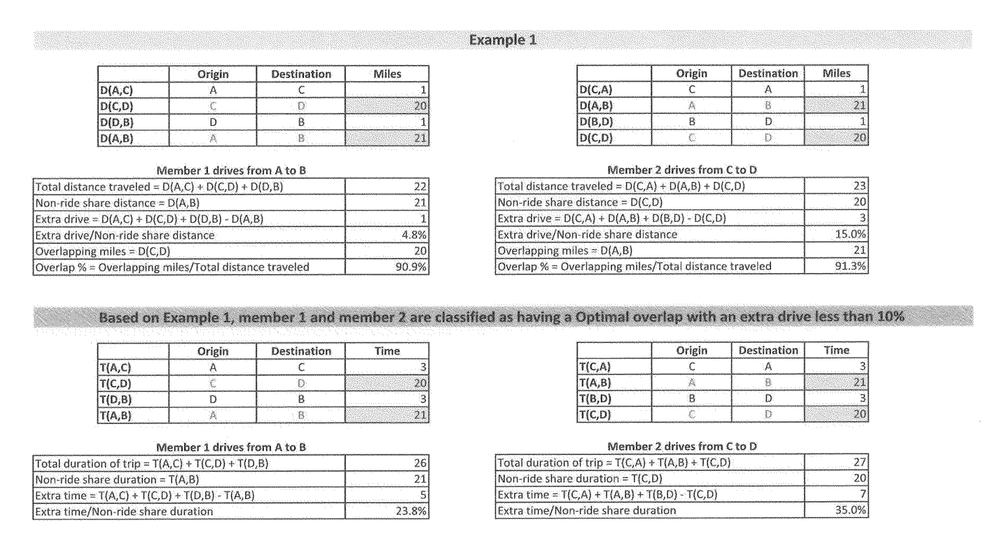

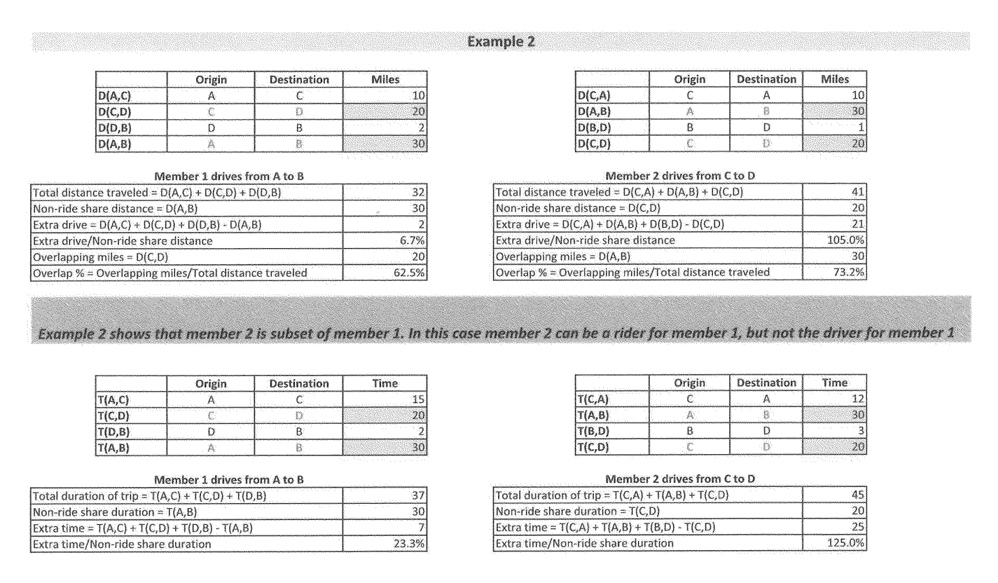

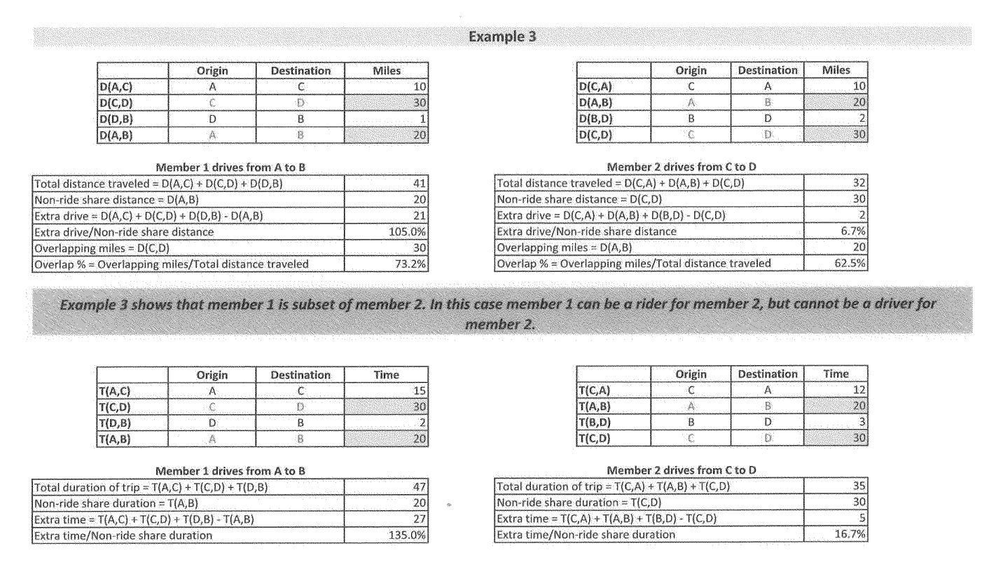

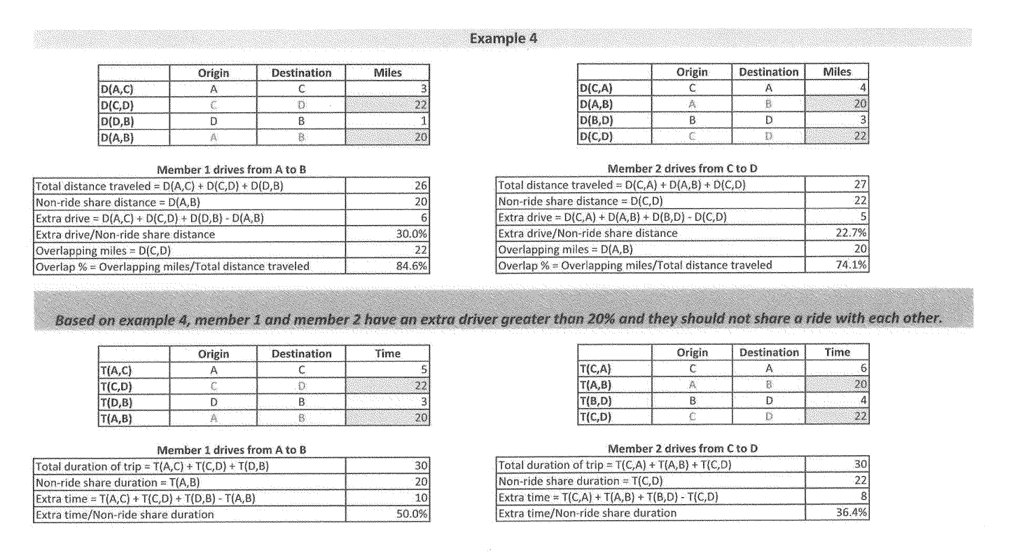

Reference is now made to FIGS. 9-10 showing example screenshots of how the ride sharing system can work to help with a member's daily commute, among other travel destinations.

In one embodiment, a ridesharing matching algorithm to be used for the embodiments disclosed herein is described as follows. The algorithm may be used by referring back to FIG. 5 depicting the different ‘subset,’ ‘super-subset,’ and ‘optimal overlap’ circles as well as Examples 1-4 to better illustrating how the matching algorithm works.

In one embodiment, the algorithm enables ride sharing by creating ride sharing circles based on how out of the way a member, e.g., the ‘driver,’ would have to go to provide a ride for another member, e.g., the ‘rider’ in terms of distance and time. The algorithm may be used in conjunction with other mapping program and/or software available online to calculate various parameters including without limitation (1) overlapping miles between driver and rider, (2) extra distance required by the driver, if any, and (3) extra drive time required by the driver, if any. Based on these and other parameters, the algorithm may suggest the best member matches for ride sharing and helps to create three different level of sharing.

In one embodiment, an optimal overlap level of sharing would have at least two members being classified as having an ‘optimal overlap’ if the ‘extra distance’ each member would have to drive to pick up the other member is less than about X % of his or her direct route, where X is a parameter that can be set by each member. For example, if the driver's origin is point A and destination is point B and the rider's origin is point C and destination is point D, we can define extra distance for a member as the distance D (A, C)+D (C, D)+D (D, B)−D (A, B), where D (A, C) is the distance between A and C, D (C, D) is the distance between C and D, D (D, B) is the distance between D and B. and D (A, B) is the distance between A and B. We can define ‘extra time’ as how much more time it would take for a driver to pick up a rider compared to not going to his or her destination directly. If it takes T (X, Y) minutes to go from point X to Y. then the ‘extra time’ may be calculate by T(A, C)+T (C, D)+T (D, B)−T (A, B). In some embodiments, the calculations may be done both ways with the assumption that each member could not only be a rider but a driver as well.

In one embodiment, a subset level of sharing would have at least one member classified as having a route that is a ‘subset’ of another member if: (1) the extra distance for the driver is less than X % of his or her own non-carpool route, where X is a parameter set by each member, (2) if the rider becomes the driver, the extra distance to be travelled would be very high (as set by the member), and (3) there is at least a Y % overlap in routes, where Y is a parameter that is optimized by the program.

In one embodiment, a super-subset level of sharing would have at least one member classified as having a route that is a ‘super-subset’ of another member if the other member has a route that is a subset of the first member.

The disclosed algorithm is able to consider various parameters including without limitation overlap distance, percentage of overlap distance. extra driving distance, percentage of extra driving distance, extra duration and percentage of extra duration, in order to evaluate which sets of members fall into the following three different circle classifications.

Although the systems. methods and computer programs have been described in detail with reference to several embodiments, additional variations and modifications exist within the scope and spirit of the disclosure.

What is claimed is:

1. A method comprising:
(a) receiving information from one or more members to create ride sharing social circles or groups;
(b) classifying the one or more members as driver, passenger or both;
(c) matching at least a portion of the information from one or more members, wherein the information includes a trip;
(d) providing contact information between at least one driver and at least one passenger depending on the amount of overlap of the trip, wherein the amount of overlap exceeds a pre-determined threshold; and
(e) rewarding the driver the number of miles travelled based on the trip.

2. The method of claim 1, wherein the trip of step (c) includes a starting point and a destination point.

3. The method of claim 1, wherein the pre-determined threshold of step (d) is at least 75%.

4. The method of claim 1, wherein the pre-determined threshold of step (d) is at least 90%.

5. The method of claim 1, wherein the matching step (c) further includes validating the one or more members having sufficient number of miles in his or her account if the member is classified as a passenger.

6. The method of claim 1, concomitant to the providing step (d), allowing the passenger to purchase the number of miles necessary before scheduling a ride with a driver.
